(19) United States
(12) Patent Application Publication
(10) Pub. No.: US 2026/0106663 A1
(43) Pub. Date: Apr. 16, 2026

(54) SYSTEMS, METHODS, AND DEVICES FOR CONTROL INFORMATION FOR NETWORK-CONTROL REPEATER (NCR)

(71) Applicant: Apple Inc., Cupertino, CA (US)

(72) Inventors: Ankit Bhamri, Bad Nauheim (DE); Hong He, San Jose, CA (US); Wei Zeng, Saratoga, CA (US); Haitong Sun, Cupertino, CA (US); Dawei Zhang, Saratoga, CA (US); Chunxuan Ye, San Diego, CA (US); Sigen Ye, San Diego, CA (US); Chunhai Yao, Beijing (CN)

(21) Appl. No.: 19/123,103

(22) PCT Filed: Nov. 2, 2023
(86) PCT No.: PCT/US2023/036646

§ 371 Date: Apr. 22, 2025

Related U.S. Application Data
(60) Provisional application No. 63/422,706, filed on Nov. 4, 2022.

(51) Int. Cl. H04B 7/155; H04W 72/232; H04W 92/18

(52) U.S. Cl. CPC H04B 7/15528; H04W 72/232; H04W 92/18

(57) ABSTRACT

Techniques herein may enable dynamic configuration of a network-control repeater (NCR) by introducing one or more DCI formats that include side control information (SCI) for configuring a control link, backhaul link, and/or access link of the NCR. One or more DCI formats may be used. An NCR may provide a base station with capability information, in terms of SCI, supported by the NCR. The base station may determine a DCI format based on the capability information and provide the configuration for each aspect of the SCI supported by the NCR in a DCI format. The NCR may receive the configurations, detect the presence/absence of one or more fields, and calculate the size of the new DCI format. Doing so may enable the NCR to detect the new DCI format in a search space and self-configure accordingly. The NCR may be dynamically configured to receive SCI via the new DCI format.

### REFERENCE TO RELATED APPLICATIONS

This Application claims the benefit of U.S. Provisional Application No. 63/422,706, filed on Nov. 4, 2022, the contents of which are hereby incorporated by reference in their entirety.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling network nodes and access points to communicate with one another in a variety of ways. In some scenarios, this may include establishing wireless connections between the wireless access points and repeaters of the network.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example of a network-control repeater (NCR) according to one or more implementations described herein.

FIG. 3 is a diagram of an example process for control information for an NCR according to one or more implementations described herein.

FIG. 4 is a diagram of an example of a table for indicating control information for links of an NCR according to one or more implementations described herein.

FIG. 5 is a diagram of an example of a side control information (SCI) payload size without cyclic redundancy check (CRC) according to one or more implementations described herein.

FIG. 6 is a diagram of an example of a table of downlink control information (DCI) format fields according to one or more implementations described herein.

FIG. 7 is a diagram of an example of components of a device according to one or more implementations described herein.

FIG. 8 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 9 is a block diagram of an example process for control information for an NCR according to one or more implementations described herein.

FIG. 10 is a block diagram of an example process for control information for an NCR according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE may refer to a smartphone, tablet computer, wearable wireless device, a vehicle capable of wireless communications, and/or another type of a broad range of wireless-capable device.

A base station may communicate with a UE via a network-controlled repeater (NCR). The NCR may operate to extend a coverage area of the base station. The base station may communicate with the NCR via a control link and a backhaul link. The control link may enable the base station to configure and manage the NCR using side control information (SCI). The backhaul link, in combination with an access link, may provide one or more channels through which data may be communicated between the base station and the UE. The channels or beams used for the backhaul link and the control link may be static or fixed.

However, while downlink control information (DCI) may enable a base station to dynamically control direct communications with a UE, and while SCI may theoretically enable a base station to configure an NCR, currently available techniques may not be suitable for enabling the dynamic control and configuration of communications between a base station and a UE via NCR. For example, currently available DCI formats fail to provide solutions for transmitting SCI to dynamically indicate access link and/or control/backhaul link beam information (e.g., configured beams), turn beams on or off, indicate uplink (UL) and downlink (DL) (UL-DL) time division duplex (TDD) configurations, and behavior over flexible symbols. Known techniques involving DCI formats for UE may not be suitable with respect to base station and NCR configurations due to the different operational nature of UEs and NCRs. As such, currently available techniques further fail to provide control information designs and formats for configuring the control link, backhaul link, and/or access link of an NCR.

The techniques described herein may be used for dynamically configuring an NCR by introducing one or more DCI formats that include control information for the control link, backhaul link, and access link of the NCR. In some implementations, a DCI format may be used. In such scenarios, the DCI format may include specific fields and relevant dependencies on supported and/or reported NCR capabilities. In other implementations, multiple DCI formats may be used (e.g., one for the backhaul link and control link and another for the access link). In such scenarios, DCI size and alignment features may be configured according to a physical downlink control channel (PDCCH) monitoring and search space configuration.

An NCR may provide a base station with capability information, in terms of SCI, supported by the NCR. As described herein, SCI may include indications or instructions for creating or configuring beams, turning beams on or off, indicating UL-DL TDD configurations, indicating behavior over flexible symbols, and more. Based on the capability information, the base station may determine a configuration for each aspect of the SCI supported by the NCR and may provide the NCR with the configurations in a DCI format. The NCR may receive the configurations of each aspect of the SCI and may detect the presence/absence of one or more fields and calculate the size of the new DCI format. As such, the NCR may be dynamically configured to receive SCI via the new DCI format. Later, upon receiving SCI via the DCI format, the NCR may perform DCI size alignment based on the calculated size and semi-static configuration of the DCI format. And the NCR may perform blind decoding based on a search space configuration and DCI size alignment to detect and then decode the SCI of the DCI format. The NCR may use the decoded SCI to configure or reconfigure one or more of the control link, the backhaul link, or the access link. Control information as used herein may refer to SCI or DCI, and a base station may send control information to an NCR via a DCI format that is dynamically configured by the base station based on NCR capability information. Details and examples of these and many other features are described below with reference to the Figures.

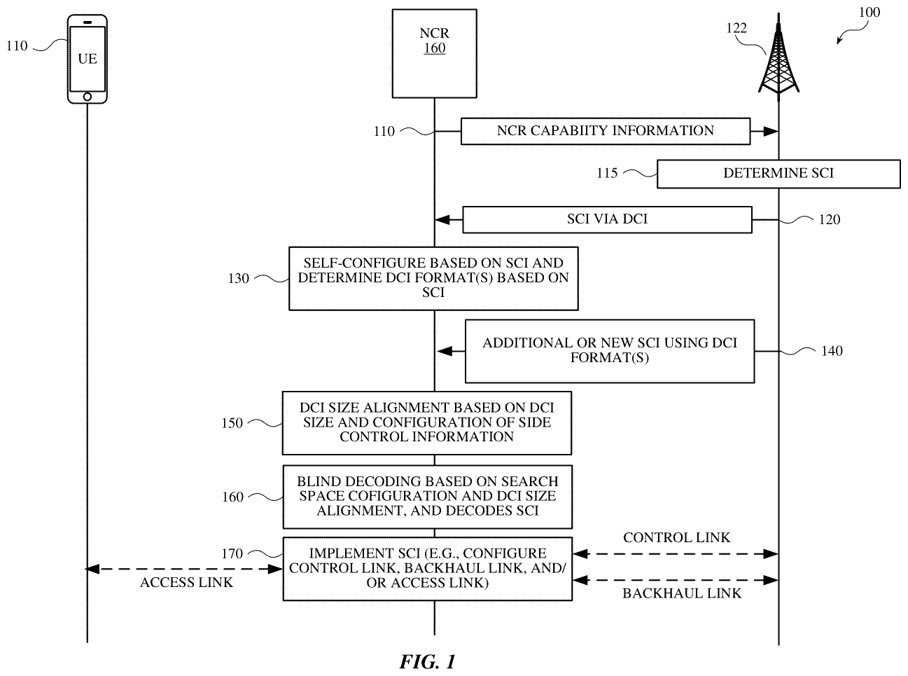

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP).

Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with (e.g., be communicatively coupled) RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). As seen hereafter, elements 122-1 and 122-1 may be individually referred to as RAN node, base station, or the like, and may be collectively referred to as RAN nodes, base stations, or the like. In such a scenario, one network node may operate as a master node (MN) and the other as the secondary node (SN).

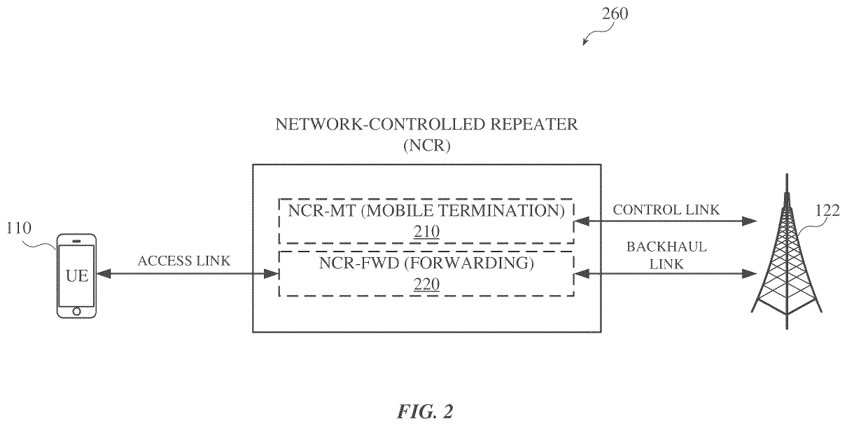

In some implementations, UE 110 and base station 122 may communicate with one another via NCR 160. NCR 160 may operate as a repeater to improve signal quality and/or extend a coverage area of base station 122. NCR 160 may communicate with UE 110 via an access link, and base station 122 via a control link and backhaul link. The control link may enable base station 122 to control the configuration and operation of NCR 160, and the backhaul link may be used to communicate data between base station 122 and UE 110. NCR 160 may be configured to use a fixed beam for the control link and the backhaul link. As described herein, base station 122 may dynamically configure NCR 160 (e.g., the control link, the backhaul link, and/or the access link) using one or more DCI formats for SCI. An example of NCR 160 is discussed below with reference to FIG. 2.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection interface 118 may comprise a local wireless connection, such as a connection consistent with any IEEE 702.11 protocol, and A P 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gN B-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink (UL) and downlink (DL) dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDM communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed band or spectrum may include the 5 GHz band. In an additional or alternative example, an unlicensed spectrum may include the 5 GHz unlicensed band, a 6 GHz band, a 60 GHz millimeter wave band, and more.

A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using stand-alone unlicensed operation, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

A physical downlink control channel (PDSCH) may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein several CCEs (e.g., 6 or the like) may consist of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. In some implementations, such as a standalone (SA) implementation, interface 123 may be an Xn interface. In some implementations, such as non-standalone (NSA) implementations, interface 123 may represent an X2 interface and an XN interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 may also, or alternatively, be configured to support one or more communication services (e.g., voice over IP (VoIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

FIG. 2 is a diagram 260 of an example of NCR 160 according to one or more implementations described herein. As shown, NCR 160 may include one or more NCR mobile termination (NCR-MT) components 210 and one or more NCR forwarding (NCR-FWD) components 220. Generally, NCR 160 and the components of NCR 160 may be implemented as a combination of hardware and software configured to enable NCR 160 to perform the operations, processes, and functions described herein. While not shown, examples hardware components of NCR 160 may include one or more antennas, radio frequency circuitry, baseband circuitry, power management circuitry, application circuitry, inter-component interface circuitry, communication interfaces, processors, memory devices, storage devices, etc. The hardware components may be configured to store, execute, and otherwise support information and software instructions consistent with performing one or more of the techniques described herein.

Generally, NCR 160 may function as a repeater for information between base station 122 (or another type of network access point device) and UE 110. The hardware and software of NCR 160 may be arranged and configured to implement NCR-MT component 210 and NCR-FWD component 220. As shown, NCR-MT component 210 may operate to establish and maintain a control link (C-link) with base station 122. The control link may be based on an NR Uu interface and may enable an exchange of information (e.g., side control information or SCI) between NCR 160 and base station 122. Side control information may enable the configuration and control of NCR-FWD component 220. For example, side control information may be used to indicate beam information (e.g., configured beams), turn beams on or off, indicate a UL-DL TDD configuration, and a behavior of NCR 160 over flexible symbols.

NCR-FWD component 220 may operate to establish a backhaul link with base station 122 and an access link with UE 110. NCR-FWD component 220 may perform amplify-and-forwarding of UL/DL RF signals between gNB and UE via the backhaul link and access link. NCR 160 may configure, modify, and control the functionality of NCR-FWD component 220 based on side control information received from base station 122. The channel/beams for the backhaul link and the control link may be static or fixed. A beam used for an access link may be referred to as an access beam or access link beam. A beam used for a backhaul link may be referred to as a backhaul beam or a backhaul link beam. A beam used for a control link may be referred to as a control beam or a control link beam.

Additionally, a beam may be a fixed beam or an adaptive or temporary beam. A fixed beam may include a beam that is used as a permanent or default beam (e.g., a beam used to maintain a link intended to be fundamental and regularly used for communications between devices). By contrast, an adaptive beam may include a beam that is used periodically or temporarily so that, for example, NCR 160 may address temporary condition, demands, or scenarios of the network. For instance, NCR 160 may use a fixed beam for a control link so that base station 122 may send control and configuration information to NCR 160. As another example, when an access link with UE 110 is established via an access beam, NCR 160 may use an adaptive beam to establish a corresponding connection with base station 120. Once the access link is no longer needed, NCR 160 may discontinue to the access beam and corresponding backhaul beam, but the fixed beam for the control link may remain in place.

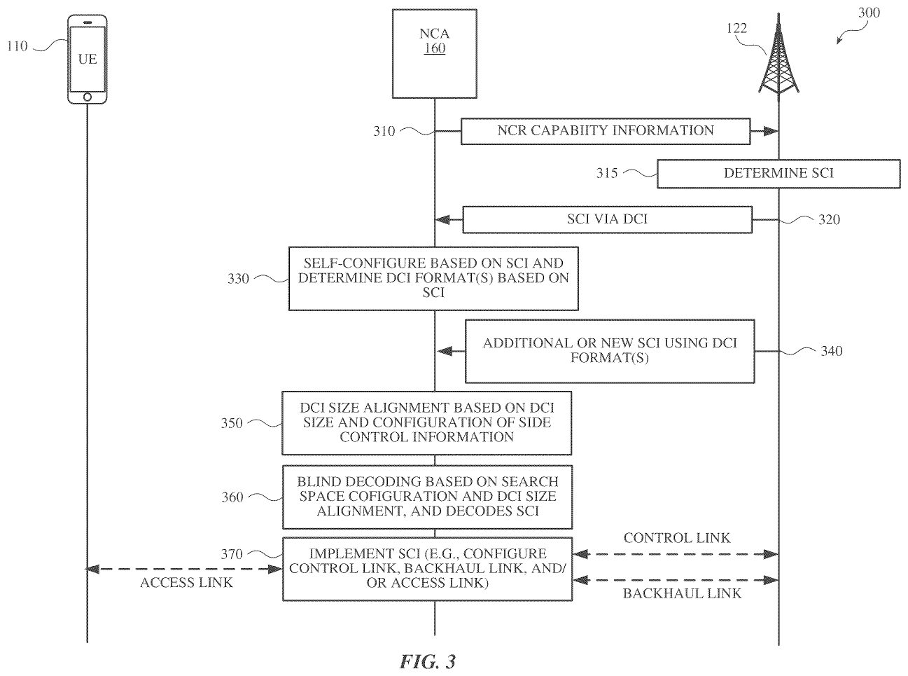

FIG. 3 is a diagram of an example process 300 for control information for NCR 160 according to one or more implementations described herein. Process 300 may be implemented by UE 110, NCR 160, and base station 122. In some implementations, some or all of process 300 may be performed by one or more other systems or devices, including one or more of the devices of FIG. 1. Additionally, process 300 may include one or more fewer, additional, differently ordered and/or arranged operations than those shown in FIG. 3, including other processes and/or operations discussed herein. For example, process 300 may include operations preceding, performed in parallel with, and/or following one or more of the depicted operations. Furthermore, some or all of the operations of process 300 may be performed independently, successively, simultaneously, etc., of one or more of the other operations of process 300. As such, the techniques described herein are not limited to a number, sequence, arrangement, timing, etc., of the operations or process depicted in FIG. 3.

As shown, process 300 may include NCR 160 sending capability information to base station 122 (at 310). The information may describe or indicate the types of SCI that NCR 160 may support. SCI may include beam configurations or information, turning beams on or off, UL-DL TDD configurations, indicating behavior over flexible symbols, and more. The SCI may relate to one or more links (e.g., the control link, backhaul link, or access link) and/or one or more components of NCR 160 (e.g., NCR-MT 210 or NCR-FWD 220). For example, there may be SCI for the control link, SCI for the backhaul link, and SCI for the access link. As another example, there may be SCI for NCR-MT 210 and SCI for NCR-FWD 220.

Base station 122 may determine SCI based on the capability information from NCR 160 (at 315) and provide the SCI to NCR 160 (at 320). NCR 160 may self-configure based on the SCI and determine a DCI format based on the SCI (at 330). For example, the SCI may include information or instructions for configuring the control link, backhaul link, or access link; NCR-MT 210 or NCR-FWD 220; etc. The information or instructions may be provided in certain fields, which may be arranged according to link type or NCR component type.

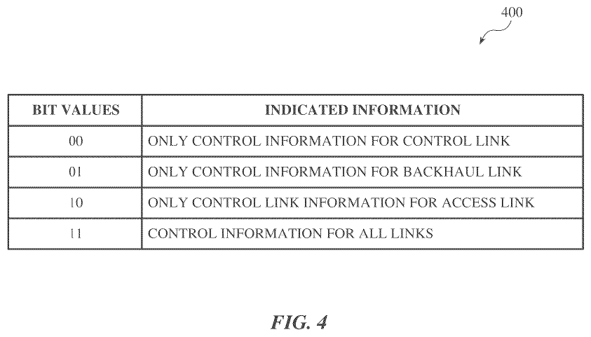

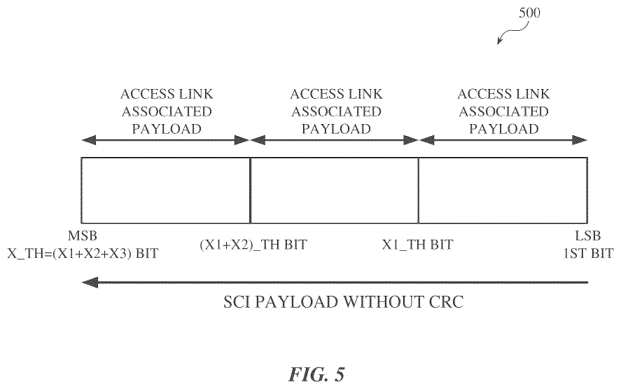

NCR 160 may determine the DCI format by detecting the presence or absence of DCI fields used to convey the SCI and by calculating the size of the DCI format. Doing so may enable NCR 160 to detect control information (e.g., DCI) sent from base station 122. In some implementations, a single DCI format may be used. In other implementations, multiple sets of SCI and multiple DCI formats may be used. The DCI format may correspond to a semi-static configuration of NCR 160. In other words, while new or additional control information (SCI or DCI) with different values may be received later, the control information is received using the same DCI format (or DCI formats), amounting to a semi-static configuration of NCR 160 and receiving control information. Additional details and examples of determining the DCI format are discussed below with reference to FIG. 4. Additional details and examples of determining the size of a DCI format are discussed below with reference to FIG. 5.

A DCI format for SCI, as described herein, may include one or more fields, arrangements of information, and so on. A single DCI format (which may be a new DCI for SCI) may be used for NCR 160. In some implementations, the DCI format may dynamically indicate one or more of the following types of control information for control link associated signaling: a transmission configuration indicator (TCI) for the control link; a transmit power control for UL transmissions from NCR-MT 210 to base station 122; a flexible symbol behavior; and/or a PDSCH (with SCI) scheduling related fields. In some implementations, fields used for PDSCH scheduling may be similar to legacy DCI formats for PDSCH scheduling such as a frequency domain resource allocation (TDRA) field, a frequency domain resource allocation (FDRA) field, antenna port(s), corresponding PUCCH with HARQ scheduling, etc.

Additionally, or alternatively, the DCI format may dynamically indicate one or more of the following types of control information for backhaul link associated signaling: a TCI for a backhaul link and/or a transmit power control for UL forwarding from NCR-FWD 220 to base station 122. Additionally, or alternatively, the format may dynamically indicate one or more of the following types of control information for access link associated signaling: an access beam index; a TDRA for access beam index; an explicit ON-OFF pattern indication; a flexible symbol behavior indication; and/or a transmit power control for downlink forwarding from NCR-FWD 220 to UE 110.

Additionally, or alternatively, the SCI (or DCI format) may include a field to indicate information types contained in the format. For example, the SCI may indicate that the format only includes control information for the control link, only includes information for the backhaul link, only includes information for the access link, or includes control information for two or more of the links (including any combination thereof).

At some point, base station 122 may use the DCI format to communicate additional or new SCI to NCR 160 (at 340). In some implementations, base station 122 may do so in response to one or more prompts, such as NCR 160 having sent base station 122 a message about UE 110 connecting to the network or UE capability information. NCR 160 may perform DCI size alignment based on the DCI format size and self-configuration implemented based on previously received SCI (at 350). NCR 160 may then perform blind decoding based on a search space configuration, the DCI format size alignment and may also decode the SCI (at 360). DCI format size alignment may include truncating the size of DCI or increasing the size of DCI by zero padding. This may be implemented to limit the number of DCI formats of different sizes. For example, NCR 160 may support only single DCI size monitoring and in this example, a DCI format that is used for indicating the DCI may be aligned to match the single DCI size supported by NCR 160.

In response to decoding the SCI received via the DCI format, NCR 160 may implement the SCI (at 370). For example, NCR 160 may configure or reconfigure the control link, the backhaul link, or the access based on the decoded SCI. Accordingly, the techniques described herein may be used to dynamically provide control information to NCR 160 based on capability information provided by NCR 160 to base station 122.

FIG. 4 is a diagram of an example of a table 400 for indicating information types associated with SCI. As shown, a 2-bit field that may be included in a DCI format as described herein. The 2-bit field (e.g., 00, 01, etc.) may be used to indicate the types of link or links to which SCI pertains. In some implementations, multiple and/or different sized fields may be used. Further, different, additional, and/or alternative links and/or combinations of links may be indicated. For example, a 3-bit indicator of a single field (or a combination of 2 fields (e.g., a 1-bit field and a 2-bit field) may be used to indicate different combinations of the control link, backhaul link, and/or access link, in addition to the link options depicted in FIG. 4. Table 400 is, therefore, provided as a non-limiting example. In some implementations, the SCI may indicate two information types. One may be for NCR-MT 210 (e.g., the control link), and the other may be for NCR-FWD 220 (e.g., the backhaul link and/or access link).

Detection of a DCI format and/or of SCI therein may involve or be facilitated by one or more features, configurations, etc. NCR 160 may be configured by base station 122 with NCR-specific radio network temporary identity (RNTI). The RNTI may be used to scramble and descramble the cyclic redundancy check (CRC) added to bits of a DCI format. In some implementations, a single RNTI may be configured to scramble the CRC bits. In some implementations, NCR 160 may be configured to use multiple RNTIs, corresponding to different SCI, which may be contained within a particular DCI format. In some implementations, NCR 160 may be configured with multiple (e.g., 4) RNTIs corresponding to multiple (e.g., 4) modes of information. Non-limiting examples of such modes of information may include: only control information for control link; only control information for backhaul link; only control information for access link; and control information for all links including control, backhaul and access link. When, for example, NCR 160 is configured with 4 RNTIs, then NCR 160 may use CRC scrambling and descrambling to detect one of the above 4 modes, and in such a scenario, no bitfield may be needed. In some implementations, when for example NCR 160 is configured with 2 RNTIs, 1 of the RNTIs may correspond to information associated with NCR-MT 210 (e.g., the control link) and the other RNTI may correspond to information associated with NCR-FWD 220 (e.g., the backhaul link and access link).

FIG. 5 is a diagram of an example 500 of an SCI payload size without CRC according to one or more implementations described herein. As shown, table 500 includes an SCI payload associated with an access link, an SCI payload associated with a backhaul link, and an SCI payload associated with a control link. Additionally, a most significant bit (MSB) may be represented as X_th=(X1+X2+X3) bit. A bit between the access link and backhaul link portions may be represented as (X1+X2)_th bit. A bit between the backhaul link and control link portions may be represented as the X1_th bit. And a least significant bit at the end of the control link portion may be represented as the 1st bit.

Size determination of a DCI format and/or of SCI therein may involve or be facilitated by one or more features, configurations, etc. For example, NCR 160 may be configured to monitor and receive one DCI format for SCI. The SCI payload size X of the payload may vary depending on a static and/or semi-static configuration corresponding to the SCI. A Maximum and minimum size of the DCI format may be fixed. In some implementations, the SCI payload variable size X may be determined individually for the three categories based on a static and/or semi-static configuration. For instance, X1 bits may be for information related to the control link; X2 bits may be for information related to the backhaul link; and X3 bits may be for information related to the access link.

As such, X may be equal to X1+X2+X3. In such scenarios, when size X is determined by NCR 160 based on static and/or semi-static configuration from base station 122, NCR 160 may only monitor SCI with the determined size X and use the configured RNTI for scrambling. In some implementations, the SCI payload size X may be equal to X1+X2, where X1 bits are for NCR-MT 210 (e.g., control link) related information, and X2 bits are for NCR-FWD 220 (e.g., backhaul link and access link) related information. In some implementations, NCR 160 may be semi-statically configured to determine DCI format size based on whether and which of the payload categories (e.g., X=X1+X2+X3 or X=X1+X2) is contained in the SCI. In such scenarios, zero padding may not be used for payload categories not included in the semi-static configuration.

In some implementations, the DCI format may involve zero padding. Zero padding may include a scenario in which bits with value “0” are added to the DCI format (e.g., for size or location adjustment). Based on SCI configuration received from base station 122, NCR 160 may determine if and where zero padding (i.e., adding 0 bits) is used done by base station 122. NCR 160 may do so based on one or more of a field designated to provide such information and/or an RNTI used to descramble said information. In some implementations, NCR 160 may also, or alternatively, determine if and where zero padding (i.e., adding bits with value “0”) is used based on a semi-statically determined size of X and/or X1, X2, and X3.

In some implementations, zero padding may be applied individually to each of the payload categories (e.g., access link, backhaul link, or control link) such that none, all, or some but not all may use zero padding. In some implementations, when NCR 160 determines based on the corresponding information field and/or RNTI that only control link information is provided, then all X2 and X3 bits may be zero padded in their respective locations within the bitmap. In some implementations, when NCR 160 determines based on the corresponding information field and/or RNTI that only backhaul link information is provided, then all X1 and X3 bits may be zero padded in their respective locations within the bitmap. In some implementations, when NCR 160 determines based on the corresponding information field and/or RNTI determine that only access link information is provided, then all X1 and X2 bits may be zero padded in their respective locations within the bitmap.

In some implementations, NCR 160 may determine zero padding based on two payload categories, where one corresponds to NCR-MT 210 and the other corresponds to NCR-FWD 220. In some implementations, NCR 160 may determine that zero padding is applied together at the end of the bitmap. In such implementations, the position of respective payload categories may be shifted as needed given the DCI format and actual SCI payload. Further, even when particular payload category is indicated as having padding or not, there still may be specific fields within that category that are either absent or shortened, in which case, individual padding to the particular information field may be applied by NCR 160.

In some implementations, for PDSCH scheduling related information, a single bit may be included in the DCI format to indicate whether a PDSCH is scheduled by the SCI. For example, if “0” is indicated, then no PDSCH may be scheduled and all the associated PDSCH scheduling fields may be zero padded. Otherwise, if “1” is indicated, then a PDSCH is scheduled and corresponding PD SCH scheduling fields may be set accordingly. In other implementations, a separate or specific RNTI may be assigned to scramble and descramble CRC bits of SCI to indicate whether the corresponding SCI schedules the PDSCH. In some embodiments, a separate or specific RNTI may be assigned to scramble or descramble CRC bits of SCI to indicate activation or deactivation of one or more semi-persistent beams of an access link. Additionally, or alternatively, when CRC is scrambled with the configured RNTI, then the beam index field may be interpreted to indicate activation/deactivation of the semi-persistent beams for the access link.

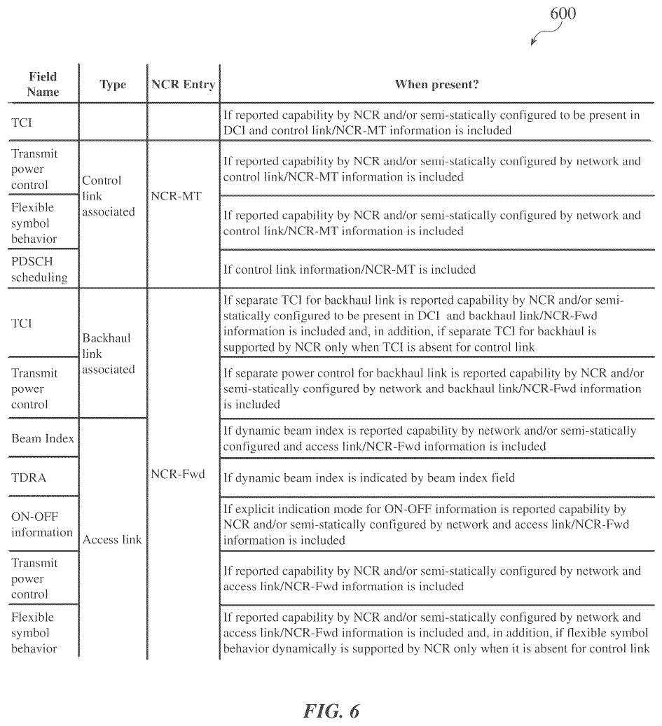

FIG. 6 is a diagram of an example of a table 600 of DCI format fields according to one or more implementations described herein. As shown, an NCR-MT portion of table 600 may include fields for a control link (e.g., a TCI field, a transmit power control field, a flexible symbol behavior field, and a PDSCH scheduling field. An NCR-FWD portion of table 600 may include a backhaul link portion and an access link portion. The backhaul link portion may include a TCI field and a transmit power field. The access link portion may include a beam index field, a TDRA field, and on-off information field, a transmit power control field and a flexible symbol behavior field.

The fields of table 600 may represent bit fields that may be present in a DCI format (e.g., for implementations where a single DCI format is used). As described herein, base station 122 may dynamically configure the DCI format according to capability of NCR 160 (e.g., by removing one or more fields). For implementations where multiple DCI formats are used, the DCI formats may include fields according to a purpose of the DCI format. For example, a DCI format for a control link and backhaul link may include one or more fields of table 600 that pertain to the control link and the backhaul link, while a DCI format for the access link may include one or more fields of table 600 that pertain to the access link. Alternatively, a DCI format for the NCR-MT 210 may include one or more fields of table 600 that pertain to the NCR-MT portion of table 600, and a DCI format for the NCR-FWD 220 may include one or more fields of table 600 that pertain to the NCF-FWD portion of table 600. As described herein, the size and/or zero padding of a particular DCI format may vary based on the DCI format determined by base station 122 based on capability information of NCR 160, the fields used, the number of DCI formats used, whether any of the fields are empty, etc.

Indeed, more than one DCI format may be configured by base station 122 to NCR 160 for PDCCH monitoring and dynamically received SCI. In some implementations, two DCI formats may be configured, where a first DCI format dynamically provides information associated with access link; and a second DCI format dynamically provides information associated with control link and backhaul link. In other implementations, two DCI formats may be configured by base station 122 to NCR 160, where a first DCI format may dynamically provide information associated with NCR-FWD 220 (e.g., information associated with a backhaul link and an access link); and a second DCI format may dynamically provide information associated with NCR-MT (e.g., information associated with a control link associated information). In yet other implementations, two DCI formats may be configured by base station 122 to NCR 160, where a first DCI format may provide backhaul, control and access link associated information; and a second DCI format may provide PDSCH scheduling information (e.g., carrying SCI) to NCR-MT 210.

When two DCI formats are configured to NCR 160, then PDCCH monitoring may be configured as follows: for the first DCI format, PDCCH monitoring may be flexibly configured in terms of a position within a slot, a duration within a slot, an aggregative level, and a slot or span based monitoring support (e.g., NCR 160 may monitor a PDCCH with the other DCI format once a slot or multiple times within a slot (at a span level)). For the second DCI format, PDCCH monitoring may be fixed in terms of one or more of a position within a slot, a duration within a slot, an aggregative level, and a slot or span based monitoring support (e.g., NCR 160 may monitor a PDCCH with the other DCI format once a slot or multiple times within a slot (at a span level). In some implementations, search space indices may be assigned first to the PDCCH monitoring with the first DCI and latter search space indices may be assigned to the PDCCH monitoring with the second DCI. In such a scenario, the first DCI may be associated with access link control information and the second DCI may be associated with control and/or backhaul link control information. Alternatively, a blind decode (BD) and/or control channel element (CCE) budget may be prioritized for the first DCI format in comparison to the second DCI format.

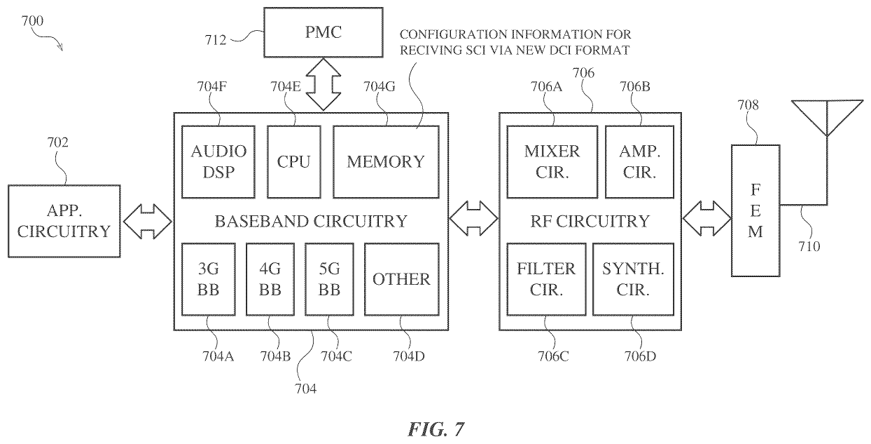

FIG. 7 is a diagram of an example of components of a device according to one or more implementations described herein. In some implementations, the device 700 can include application circuitry 702, baseband circuitry 704, RF circuitry 706, front-end module (FEM) circuitry 708, one or more antennas 710, and power management circuitry (PMC) 712 coupled together at least as shown. The components of the illustrated device 700 can be included in a UE or a RAN node. In some implementations, the device 700 can include fewer elements (e.g., a RAN node may not utilize application circuitry 702, and instead include a processor/controller to process IP data received from a CN or an Evolved Packet Core (EPC)). In some implementations, the device 700 can include additional elements such as, for example, memory/storage, display, camera, sensor (including one or more temperature sensors, such as a single temperature sensor, a plurality of temperature sensors at different locations in device 700, etc.), or input/output (I/O) interface. In other implementations, the components described below can be included in more than one device (e.g., said circuitries can be separately included in more than one device for Cloud-RAN (C-RAN) implementations).

The application circuitry 702 can include one or more application processors. For example, the application circuitry 702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 700. In some implementations, processors of application circuitry 702 can process IP data packets received from an EPC.

The baseband circuitry 704 can include circuitry such as, but not limited to, one or more single-core or multi-core processors. The baseband circuitry 704 can include one or more baseband processors or control logic to process baseband signals received from a receive signal path of the RF circuitry 706 and to generate baseband signals for a transmit signal path of the RF circuitry 706. Baseband circuitry 704 can interface with the application circuitry 702 for generation and processing of the baseband signals and for controlling operations of the RF circuitry 706. For example, in some implementations, the baseband circuitry 704 can include a 3G baseband processor 704A, a 4G baseband processor 704B, a 5G baseband processor 704C, or other baseband processor(s) 704D for other existing generations, generations in development or to be developed in the future (e.g., 5G, 6G, etc.). The baseband circuitry 704 (e.g., one or more of baseband processors 704A-D) can handle various radio control functions that enable communication with one or more radio networks via the RF circuitry 706. In other implementations, some or all of the functionality of baseband processors 704A-D can be included in modules stored in the memory 704G and executed via a Central Processing Unit (CPU) 704E. The radio control functions can include, but are not limited to, signal modulation/demodulation, encoding/decoding, radio frequency shifting, etc. In some implementations, modulation/demodulation circuitry of the baseband circuitry 704 can include Fast-Fourier Transform (FFT), precoding, or constellation mapping/de-mapping functionality. In some implementations, encoding/decoding circuitry of the baseband circuitry 704 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 704G may receive and store one or more configurations, instructions, and/or other types of information to enable dynamic configuration of NCR 160 by introducing one or more DCI formats that include SCI for configuring a control link, backhaul link, and/or access link of NCR 160. One or more DCI formats may be used. NCR 160 may provide base station 122 with capability information, in terms of SCI, supported by NCR 160. Base station 122 may determine a DCI format based on the capability information and provide the configuration for each aspect of the SCI supported by NCR 160 in a DCI format. NCR 160 may receive the configurations, detect the presence/absence of one or more fields, and calculate a size of the new DCI format. Doing so may later enable NCR 160 to detect the new DCI format in a search space and self-configure accordingly. As such, NCR 160 may be dynamically configured to receive SCI via the new DCI format.

In some implementations, the baseband circuitry 704 can include one or more audio digital signal processor(s) (DSP) 704F. The audio DSPs 704F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 704 and the application circuitry 702 can be implemented together such as, for example, on a system on a chip (SOC).

In some implementations, the baseband circuitry 704 can provide for communication compatible with one or more radio technologies. For example, in some implementations, the baseband circuitry 704 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 704 is configured to support radio communications of more than one wireless protocol can be referred to as multi-mode baseband circuitry.

RF circuitry 706 can enable communication with wireless networks using modulated electromagnetic radiation through a non-solid medium. In various implementations, the RF circuitry 706 can include switches, filters, amplifiers, etc. to facilitate the communication with the wireless network. RF circuitry 706 can include a receive signal path which can include circuitry to down-convert RF signals received from the FEM circuitry 708 and provide baseband signals to the baseband circuitry 704. RF circuitry 706 can also include a transmit signal path which can include circuitry to up-convert baseband signals provided by the baseband circuitry 704 and provide RF output signals to the FEM circuitry 708 for transmission.

In some implementations, the receive signal path of the RF circuitry 706 can include mixer circuitry 706A, amplifier circuitry 706B and filter circuitry 706C. In some implementations, the transmit signal path of the RF circuitry 706 can include filter circuitry 706C and mixer circuitry 706A. RF circuitry 706 can also include synthesizer circuitry 706D for synthesizing a frequency for use by the mixer circuitry 706A of the receive signal path and the transmit signal path. In some implementations, the mixer circuitry 706A of the receive signal path can be configured to down-convert RF signals received from the FEM circuitry 708 based on the synthesized frequency provided by synthesizer circuitry 706D. The amplifier circuitry 706B can be configured to amplify the down-converted signals and the filter circuitry 706C can be a low-pass filter (LPF) or band-pass filter (BPF) configured to remove unwanted signals from the down-converted signals to generate output baseband signals. Output baseband signals can be provided to the baseband circuitry 704 for further processing. In some implementations, the output baseband signals can be zero-frequency baseband signals, although this is not a requirement. In some implementations, mixer circuitry 706A of the receive signal path can comprise passive mixers, although the scope of the implementations is not limited in this respect.

In some implementations, the mixer circuitry 706A of the transmit signal path can be configured to up-convert input baseband signals based on the synthesized frequency provided by the synthesizer circuitry 706D to generate RF output signals for the FEM circuitry 708. The baseband signals can be provided by the baseband circuitry 704 and can be filtered by filter circuitry 706C.

In some implementations, the mixer circuitry 706A of the receive signal path and the mixer circuitry 706A of the transmit signal path can include two or more mixers and can be arranged for quadrature down conversion and up conversion, respectively. In some implementations, the mixer circuitry 706A of the receive signal path and the mixer circuitry 706A of the transmit signal path can include two or more mixers and can be arranged for image rejection (e.g., Hartley image rejection). In some implementations, the mixer circuitry 706A of the receive signal path and the mixer circuitry 706A can be arranged for direct down conversion and direct up conversion, respectively. In some implementations, the mixer circuitry 706A of the receive signal path and the mixer circuitry 706A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 706 can include analog-to-digital converter (ADC) and digital-to-analog converter (DAC) circuitry and the baseband circuitry 704 can include a digital baseband interface to communicate with the RF circuitry 706.

In some dual-mode implementations, a separate radio IC circuitry can be provided for processing signals for each spectrum, although the scope of the implementations is not limited in this respect.

In some implementations, the synthesizer circuitry 706D can be a fractional-N synthesizer or a fractional N/N+1 synthesizer, although the scope of the implementations is not limited in this respect as other types of frequency synthesizers can be suitable. For example, synthesizer circuitry 706D can be a delta-sigma synthesizer, a frequency multiplier, or a synthesizer comprising a phase-locked loop with a frequency divider.

The synthesizer circuitry 706D can be configured to synthesize an output frequency for use by the mixer circuitry 706A of the RF circuitry 706 based on a frequency input and a divider control input. In some implementations, the synthesizer circuitry 706D can be a fractional N/N+1 synthesizer.

In some implementations, frequency input can be provided by a voltage-controlled oscillator (VCO), although that is not a requirement. Divider control input can be provided by either the baseband circuitry 704 or the applications circuitry 702 depending on the desired output frequency. In some implementations, a divider control input (e.g., N) can be determined from a look-up table based on a channel indicated by the applications circuitry 702.

Synthesizer circuitry 706D of the RF circuitry 706 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 706D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 706 can include an IQ/polar converter.

FEM circuitry 708 can include a receive signal path which can include circuitry configured to operate on RF signals received from one or more antennas 710, amplify the received signals and provide the amplified versions of the received signals to the RF circuitry 706 for further processing. FEM circuitry 708 can also include a transmit signal path which can include circuitry configured to amplify signals for transmission provided by the RF circuitry 706 for transmission by one or more of the one or more antennas 710. In various implementations, the amplification through the transmit or receive signal paths can be done solely in the RF circuitry 706, solely in the FEM circuitry 708, or in both the RF circuitry 706 and the FEM circuitry 708.

In some implementations, the FEM circuitry 708 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 706). The transmit signal path of the FEM circuitry 708 can include a power amplifier (PA) to amplify input RF signals (e.g., provided by RF circuitry 706), and one or more filters to generate RF signals for subsequent transmission (e.g., by one or more of the one or more antennas 710).

In some implementations, the PMC 712 can manage power provided to the baseband circuitry 704. In particular, the PMC 712 can control power-source selection, voltage scaling, battery charging, or DC-to-DC conversion. The PMC 712 can often be included when the device 700 is capable of being powered by a battery, for example, when the device is included in a UE. The PMC 712 can increase the power conversion efficiency while providing desirable implementation size and heat dissipation characteristics.

While FIG. 7 shows the PMC 712 coupled only with the baseband circuitry 704. However, in other implementations, the PMC 712 may be additionally or alternatively coupled with, and perform similar power management operations for, other components such as, but not limited to, application circuitry 702, RF circuitry 706, or FEM circuitry 708.

In some implementations, the PMC 712 can control, or otherwise be part of, various power saving mechanisms of the device 700. For example, if the device 700 is in an RRC Connected state, where it is still connected to the RAN node as it expects to receive traffic shortly, then it can enter a state known as discontinuous reception mode (DRX) after a period of inactivity. During this state, the device 700 can power down for brief intervals of time and thus save power.

If there is no data traffic activity for an extended period of time, then the device 700 can transition off to an RRC_Idle state, where it disconnects from the network and does not perform operations such as channel quality feedback, handover, etc. The device 700 goes into a very low power state and it performs paging where again it periodically wakes up to listen to the network and then powers down again. The device 700 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 702 and processors of the baseband circuitry 704 can be used to execute elements of one or more instances of a protocol stack. For example, processors of the baseband circuitry 704, alone or in combination, can be used execute Layer 3, Layer 2, or Layer 1 functionality, while processors of the baseband circuitry 704 can utilize data (e.g., packet data) received from these layers and further execute Layer 4 functionality (e.g., transmission communication protocol (TCP) and user datagram protocol (UDP) layers). As referred to herein, Layer 3 can comprise an RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

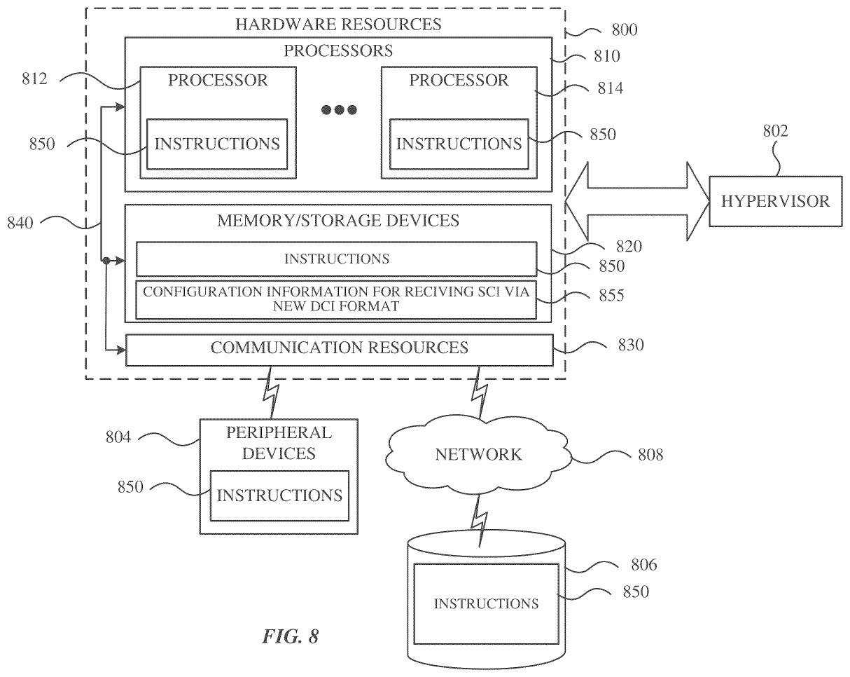

FIG. 8 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For implementations where node virtualization (e.g., NFV) is utilized, a hypervisor 802 may be executed to provide an execution environment for one or more network slices/sub-slices to utilize the hardware resources 800.

The processors 810 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 812 and a processor 814.

The memory/storage devices 820 may include main memory, disk storage, or any suitable combination thereof. The memory/storage devices 820 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 820 may receive and store one or more configurations, instructions, and/or other types of information 855 to enable dynamic configuration of NCR 160 by introducing one or more DCI formats that include SCI for configuring a control link, backhaul link, and/or access link of NCR 160. One or more DCI formats may be used. NCR 160 may provide base station 122 with capability information, in terms of SCI, supported by NCR 160. Base station 122 may determine a DCI format based on the capability information and provide the configuration for each aspect of the SCI supported by NCR 160 in a DCI format. NCR 160 may receive the configurations, detect the presence/absence of one or more fields, and calculate a size of the new DCI format. Doing so may later enable NCR 160 to detect the new DCI format in a search space and self-configure accordingly. As such, NCR 160 may be dynamically configured to receive SCI via the new DCI format.

The communication resources 830 may include interconnection or network interface components or other suitable devices to communicate with one or more peripheral devices 804 or one or more databases 806 via a network 808. For example, the communication resources 830 may include wired communication components (e.g., for coupling via a universal serial bus (USB)), cellular communication components, NFC components, Bluetooth® components (e.g., Bluetooth® low energy), Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

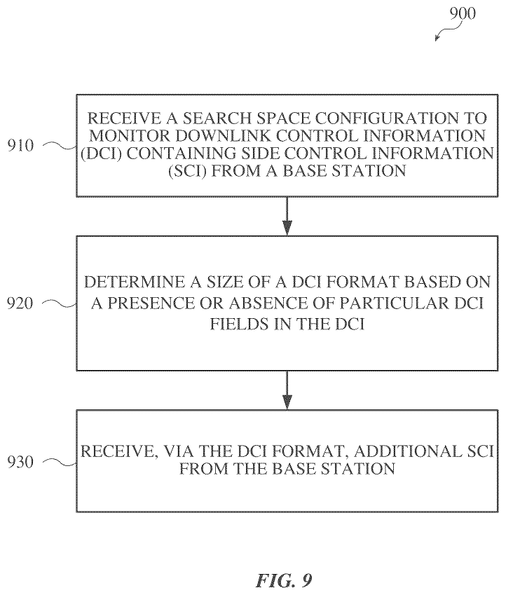

FIG. 9 is a block diagram of an example process 900 for control information for an NCR according to one or more implementations described herein. Process 900 may be implemented by NCR 160. As shown, NCR 160 may receive a search space configuration to monitor DCI containing side control information (SCI) from a base station (block 910). NCR 160 may monitor the search space for the DCI containing the SCI. NCR 160 may configure a control link, a backhaul link, and/or an access link based on the SCI. NCR 160 may determine a size of a DCI format based on a presence or absence of particular DCI fields in the DCI (block 920). NCR 160 may receive, via the DCI format, new or additional DCI containing new or additional SCI from the base station (block 930). NCR 160 may create a new and/or reconfigure an existing control link, backhaul link, and/or an access link based on the new or additional SCI communicated via the DCI format.

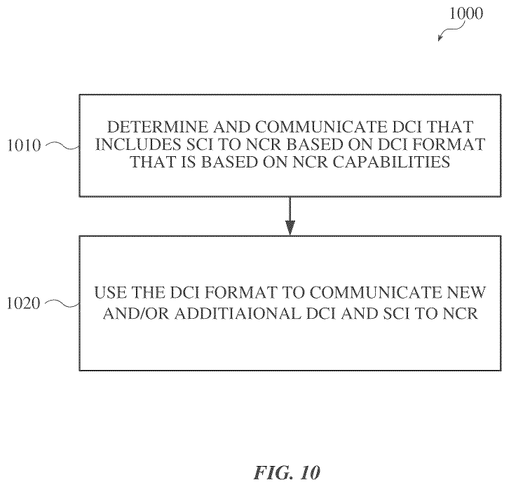

FIG. 10 is a block diagram of an example process 1000 for control information for an NCR according to one or more implementations described herein. Process 1000 may be performed by base station 122. As shown, base station 122 may determine and communicate DCI that includes SCI to NCR 160 (block 1010). Base station 122 may receive capability information of NCR 160 and/or UE 110, and base station 122 may determine a DCI format for providing DCI with SCI to NCR. Base station 122 may use the DCI format to provide the DCI and SCI. Base station 122 may also use the DCI format to provide new and/or additional DCI with SCI to NCR 160 using the DCI format (block 1020).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.
In example 1, which may also include one or more of the examples described herein, a network-controlled repeater (NCR) may comprising: a memory; and one or more processors configured to, when executing instructions stored in the memory, cause the NCR to: receive a search space configuration to monitor downlink control information (DCI) containing side control information (SCI) from a base station; determine a size of a DCI format based on a presence or absence of particular DCI fields in the DCI; and receive, via the DCI format, additional SCI from the base station. In example 2, which may also include one or more of the examples described herein, the SCI is provided by a single DCI format, and the SCI includes control information for configuring a control link between the NCR and the base station, a backhaul link and the base station, and an access link between the NCR and a user equipment (UE).
In example 3, which may also include one or more of the examples described herein, the DCI format includes one or more fields that indicate whether the SCI only includes information for a control link, only includes information for a backhaul link, only includes information for an access link, or includes information the control link, the backhaul link, and the access link. In example 4, which may also include one or more of the examples described herein, each of the one or more fields comprises a 2-bit field. In example 5, which may also include one or more of the examples described herein, the NCR is configured, by the base station, with one or more NCR-specific radio network temporary identities (RNTIs), and the NCR is configured to use the one or more RNTIs to scramble and descramble cyclic redundancy checks (CRCs) bits of the DCI format.
In example 6, which may also include one or more of the examples described herein, the SCI comprises an access link portion, a backhaul link portion, and a control link portion, and the NCR is configured to determine the DCI format size based on a size of each of the access link portion, a backhaul link portion, and a control link portion. In example 7, which may also include one or more of the examples described herein, the NCR is configured to monitor and receive the additional SCI based on a size of each of the access link portion, the backhaul link portion, and the control link portion. In example 8, which may also include one or more of the examples described herein, the SCI comprises an NCR mobile termination (NCR-MT) portion and an NCR forwarding (NCR-FWD) portion, the NCR-MT portion corresponding to a control link between the NCR and the base station, and the NCR-FWD portion corresponding to a backhaul link between the NCR and the base station and an access link between the NCR and a user equipment (UE).
In example 9, which may also include one or more of the examples described herein, the NCR is configured to determine the DCI format size based on a size of each of the NCR-MT portion and the NCR-FWD portion. In example 10, which may also include one or more of the examples described herein, the NCR is configured to determine whether the base station has used zero padding on one or more fields, portions, or an RNTI of the DCI format. In example 11, which may also include one or more of the examples described herein, the DCI format includes a 1-bit indication of whether physical downlink shared channel (PDSCH) scheduling information is included in the DCI format.
In example 12, which may also include one or more of the examples described herein, the NCR is configured to use an RNTI to descramble CRC bits of the DCI format to determine whether PDSCH scheduling information is included in the DCI format. In example 13, which may also include one or more of the examples described herein, the NCR is configured to use one or more RNTIs to descramble one or more sets of CRC bits to determine whether to activate or deactivate one or more access links. In example 14, which may also include one or more of the examples described herein, one DCI format may be used for SCI regarding a control link and another DCI format may be used for SCI regarding a backhaul link and an access link.
In example 15, which may also include one or more of the examples described herein, one DCI format may be used for SCI regarding a control link and a backhaul link and another DCI format may be used for SCI regarding an access link. In example 16, which may also include one or more of the examples described herein, one DCI format may be used for SCI regarding an NCR-MT of the NCR and another DCI format may be used for SCI regarding an NCR-FWD of the NCR. In example 17, which may also include one or more of the examples described herein, the DCI format includes a first DCI format and a second DCI format and physical downlink control channel (PDCCH) monitoring may be configured to be flexible for a first DCI format and static for a second DCI format.
In example 18, which may also include one or more of the examples described herein, search space indices are assigned first to the PDCCH monitoring of the first DCI format and remaining search space indices are assigned to the PDCCH monitoring of the second DCI format. In example 19, which may also include one or more of the examples described herein, the PDCCH monitoring corresponds to one of fixed slots, fixed symbols within a slot, a fixed duration, or a combination thereof. In example 20, which may also include one or more of the examples described herein, the first DCI format is associated with access control link information and the second DCI format is associated with backhaul link information and control link information.
In example 21, which may also include one or more of the examples described herein, a method, performed by a network-controlled repeater (NCR), may comprise: receiving a search space configuration to monitor downlink control information (DCI) containing side control information (SCI) from a base station; determining a size of a DCI format based on a presence or absence of particular DCI fields in the DCI; and receiving, via the DCI format, additional SCI from the base station.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom.

Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. A network-controlled repeater (NCR), comprising:
a memory; and
one or more processors configured to, when executing instructions stored in the memory, cause the NCR to:
receive a side control information (SCI) configuration and a search space configuration from a base station;
determine a size of a downlink control information (DCI) format based on the received SCI configuration;
monitor for DCI associated with the DCI format based on the received search space configuration and the determined size; and
receive, via a the DCI associated with the DCI format, SCI from the base station.

2. The NCR of claim 1, wherein the SCI is provided by a single DCI format, and the SCI includes control information for configuring an access link between the NCR and a user equipment (UE).

3. The NCR of claim 1, wherein the NCR is configured, by the base station, with one or more NCR-specific radio network temporary identities (RNTIs), and the NCR is configured to use the one or more NCR-specific RNTIs to scramble and descramble cyclic redundancy checks (CRCs) bits of the DCI format.

4. The NCR of claim 1, wherein the SCI includes beam information for an access link between the NCR and a user equipment (UE).

5. The NCR of claim 1, wherein the SCI includes time domain resource allocation (TDRA) information for an access link between the NCR and a user equipment (UE).

6. The NCR of claim 1, wherein the NCR is configured to determine whether the base station has used zero padding on the DCI format.

7. The NCR of claim 1, wherein the DCI format has a dynamic size ranging between a minimum size and a maximum size.

8. The NCR of claim 1, wherein the DCI format includes one or more fields that indicate whether the SCI only includes information for a control link, only includes information for a backhaul link, only includes information for an access link, or includes information the control link, the backhaul link, and the access link.

9. The NCR of claim 1, wherein the SCI comprises an access link portion, a backhaul link portion, and a control link portion, and the NCR is configured to determine the size of the DCI format based on a size of each of the access link portion, the backhaul link portion, and the control link portion.

10. The NCR of claim 1, wherein the SCI comprises an NCR mobile termination (NCR-MT) portion and an NCR forwarding (NCR-FWD) portion, the NCR-MT portion corresponding to a control link between the NCR and the base station, and the NCR-FWD portion corresponding to a backhaul link between the NCR and the base station and an access link between the NCR and a user equipment (UE).

11. The NCR of claim 1, wherein the DCI format includes a 1-bit indication of whether physical downlink shared channel (PDSCH) scheduling information is included in the DCI format.

12. The NCR of claim 1, wherein the NCR is configured to use an RNTI to descramble CRC bits of the DCI format to determine whether PDSCH scheduling information is included in the DCI format.

13. The NCR of claim 1, wherein the NCR is configured to use one or more RNTIs to descramble one or more sets of CRC bits to determine whether to activate or deactivate one or more access links.

14. The NCR of claim 1, wherein the DCI format is used for SCI regarding a control link and another DCI format is used for SCI regarding a backhaul link and an access link.

15. The NCR of claim 1, wherein the DCI format is used for SCI regarding a control link and a backhaul link and another DCI format is used for SCI regarding an access link.

16. The NCR of claim 1, wherein the DCI format is used for SCI regarding an NCR-MT of the NCR and another DCI format is used for SCI regarding an NCR-FWD of the NCR.

17. The NCR of claim 1, wherein the one or more processors are further configured to, when executing instructions stored in the memory, cause the NCR to:
receive, via additional DCI associated with an additional DCI format, additional SCI from the base station, wherein physical downlink control channel (PDCCH) monitoring is configured to be flexible for the DCI format and static for the additional DCI format.

18. A method, performed by a network-controlled repeater (NCR), comprising:
receiving a side control information (SCI) configuration and a search space configuration from a base station;
determining a size of a downlink control information (DCI) format based on the received SCI configuration;
monitoring for DCI associated with the DCI format based on the received search space configuration and the determined size; and
receiving, via the DCI associated with the DCI format, SCI from the base station.

19. The method according to claim 18, wherein the size of the DCI format is based on a presence or absence of DCI fields in the DCI format.

20. A non-transitory, computer-readable medium comprising instructions that when performed by one or more processors cause the one or more processors to:
receive a side control information (SCI) configuration and a search space configuration from a base station;
determine a size of a downlink control information (DCI) format based on the received SCI configuration;
monitor for DCI associated with the DCI format based on the received search space configuration and the determined size; and
receive, via the DCI associated with the DCI format, SCI from the base station.
